(19) United States
(12) Patent Application Publication
(10) Pub. No.: US 2017/0208982 A1
(43) Pub. Date: Jul. 27, 2017

(54) STIR-FRYING, WASHING, BOILING, COOKING, STEAMING UNIVERSAL POT

(71) Applicant: Fang LIU, Beijing (CN)

(72) Inventor: Fang LIU, Beijing (CN)

(21) Appl. No.: 15/328,500

(22) PCT Filed: Jul. 23, 2015
(86) PCT No.: PCT/CN2015/000526

§ 371 Date: Jan. 24, 2017

(30) Foreign Application Priority Data
Aug. 6, 2014 (CN) 201410382583.9

(51) Int. Cl. A47J 27/00; A47J 36/02; A47J 36/16

(52) U.S. Cl. CPC A47J 27/00; A47J 27/002; A47J 36/16; A47J 36/02

(57) ABSTRACT

A universal pot for stir-frying, washing, boiling, cooking or steaming food is provided. As a stir-frying pot, it stir-fries food in turning manner. The inner container of the stir-frying pot is turned like a washing machine, and stir-fries food by use of turning power, gravity, etc., and the heat of the pot. As a washing pot, it washes food in the same turning manner. As a boiling pot, it switches off the power supply automatically when the temperature reaches 100° C. The boiled vegetables peel easily. As a cooking pot or a steaming pot, it has part of functions of a microwave oven. All these five pots can be used independently, and they can also be easily transformed to each other and combined to be one pot.

### CROSS REFERENCE TO RELATED APPLICATIONS

This application is the national phase of International Application No. PCT/CN2015/000526, filed on 23 Jul. 2015, which is based upon and claims priority to Chinese Patent Application No. CN201410382583.9, filed on 6 Aug. 2014, the entire contents of which are incorporated herein by reference.

### TECHNICAL FIELD

electronic frying, washing, cooking pot.

### TECHNICAL BACKGROUND

e-pressure cooker, e-oil fryer, washing machine's turning technology.

### SUMMARY OF INVENTION

A closed stir-frying pot used the turning principle to stir-fry the food, the structure & turning is similar as the washing machine (just with relative quick tempo), but smaller than the washing machine. It has two parts (the pot's size is similar as e-pressure cooker): the out shell and the inner tub, the inner tub can turning like the washing machine's inner tub. After connected with the energy the pot begins to heat, at the same time the inner tub begins to turn, by turning and also added the heat from the pot to stir-fry the food. Its inner tub can lying vertically turning can also standing transversely turning can also universally turning, the vertically turning direction is same as drum type washing machine's turning direction, the transversely turning direction is same as pulsator type washing machine's turning direction. It used the vertically turning gravity & turning power (throwing power), and also used the transversely turning turning power (throwing power) and added the heat from the pot sometimes also added the up & down, right & left jumping power, striking power to stir-fry the food. It doesn't need any frying ladle . . . , it just used the turning principle, by turning with relative quick (like the washing machine's turning) tempo & also with one tempo or different tempos, by turning also in one direction or in different directions to stir-fry the food. There are two bottoms on the pot: the temperature bottom & the time bottom (the time bottom can be also used as on/off bottom). On the pot there is also glass-cover, by which you can see the frying food clearly. The People can leave after that they have set the time & the temperature and when it is almost fried then come to check out awhile. There are also some full-automatical menus on it, e.g. (1) frying potato: small fire 5 minutes. (2) frying rice: middle fire 10 minutes. (3) frying noodle: big fire 15 minutes . . . . The food fried from this pot will be same crisp as fried from your hands. This pot has a lot of benefits: you don't need to stir-fry front the pot with the hands, and you don't need to open the smoke exhausting machine at the same time, because it is full-automatical mechanical working & it has no smoke any more . . . . Except the stir-frying pot also a closed washing pot, its structure is also similar as the washing machine & the front going stir-frying pot, but used the turning principle to wash the food. Except the washing pot there are also boiling pot & cooking, teaming pot.

### BRIEF DESCRIPTION OF THE DRAWINGS

All the pictures only for the stir-frying pot, (picture=fig.).

FIG. 1 is the front of the pot.

FIG. 2 is the inner tub of the pot.

FIG. 3 is the front of the pot after taking out the inner tub.

FIG. 4 is turning stick.

FIG. 5 is the inner tub after taking out the handle.

FIG. 6 is the out door.

FIG. 7 is after closing the out door.

FIG. 8 & FIG. 9 are top connecting inner tubs.

FIG. 10 is top connecting inner tub after closing the out door.

FIG. 11 is the top connecting out shell after taking out the inner tub.

FIG. 12 & FIG. 13 are top & bottom connecting inner tub with changeable handle.

FIG. 14 is inner tub with changeable handle after closing the out door.

FIG. 15 is bottom connecting inner tub looking from the back.

FIG. 16 is axis connecting inner tub.

FIG. 17 is axis connecting out shell after taking out the inner tub.

FIG. 18 is axis connecting inner tub with changeable handle.

FIG. 19 is axis connecting inner tub with changeable handle after closing the out door.

FIG. 20 & FIG. 22 are completely connecting inner tub.

FIG. 21 & FIG. 23 are completely connecting out shell after taking out the inner tub.

FIG. 24 is completely connecting inner tub with changeable handle.

FIG. 25 is standable pot after closing the out door.

FIG. 26 is the standable pot after opening the out door.

FIG. 27 is the out shell opening from the top the inner tub opening from the side.

FIG. 28 is the inner tub opening from the side after taking it out from the pot can also standing.

### DETAILED DESCRIPTION OF THE INVENTION

### 1. Stir-Frying Pot:

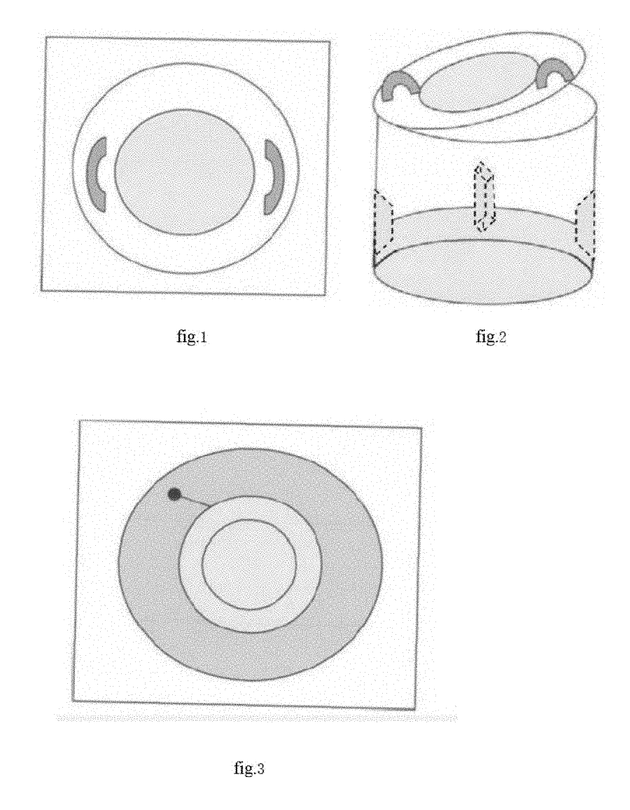

A closed stir-frying pot has two parts: the out shell and the inner tub, the out shell's heating principle is just similar as e-oil fryer, e-pressure cooker . . . (with resistance wire), its inner tub can turning and the stuff of the inner tub is non-stick stuff. On the inner wall of the inner tub there are some ridges, which are similar as the ridges on the inner wall of the washing machine's inner tub, just for making the inner wall not completely smooth. Because if you fry just a little food & use a lot of oil, the food maybe won't turning, therefore it's good for preventing adhesion (like FIG. 2A). Inside there is a smoke filter-net (like the e-oil fryer) & it has also glass-cover, by which you can see it turning. But the difference is by stir-frying you don't need a lot of oil, therefore the smoke filter-net can be maybe overseen, if you can see the turning food clearly, then you don't need it, but a lot of cheap e-oil fryer they all have it, so if it's practical you can also add it. But one thing is clear you don't need to use the smoke exhausting machine any more, let alone to clean it & also an other thing is clear, your kitchen can't be where smoke any more, because they are all inside in this pot. Big or heavy food you can also fry by this pot, e.g. big pieces of chicken, frying noodle, big, meal . . . . And Any time if you want to stop the program, you can just easily turn the time bottom to 0, and the pot will be turned off. This stir-frying pot has the following forms:

(6) Inner Tub with Turning Stick:

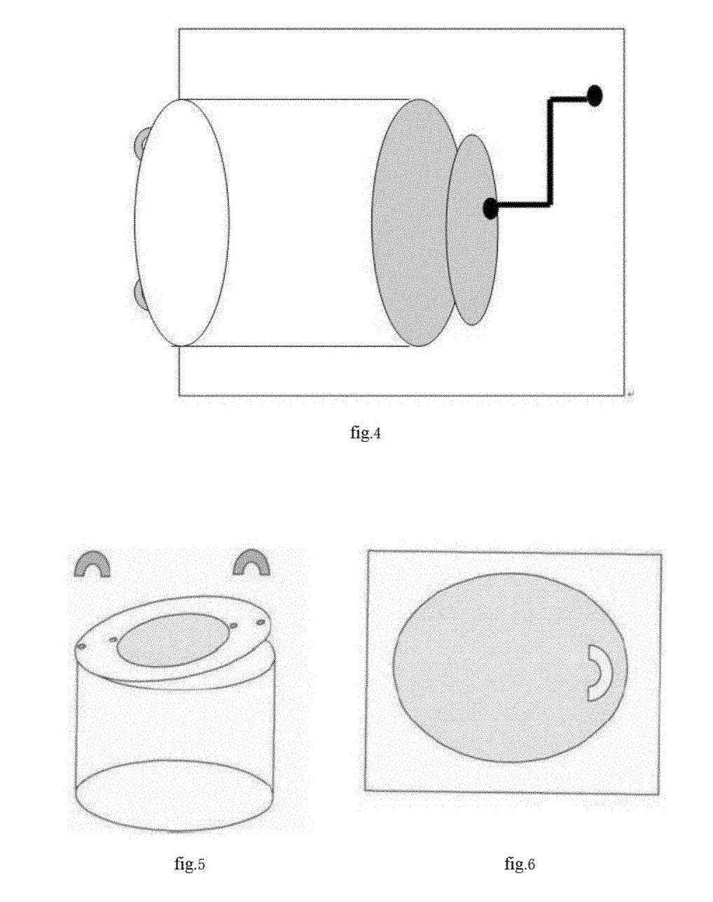

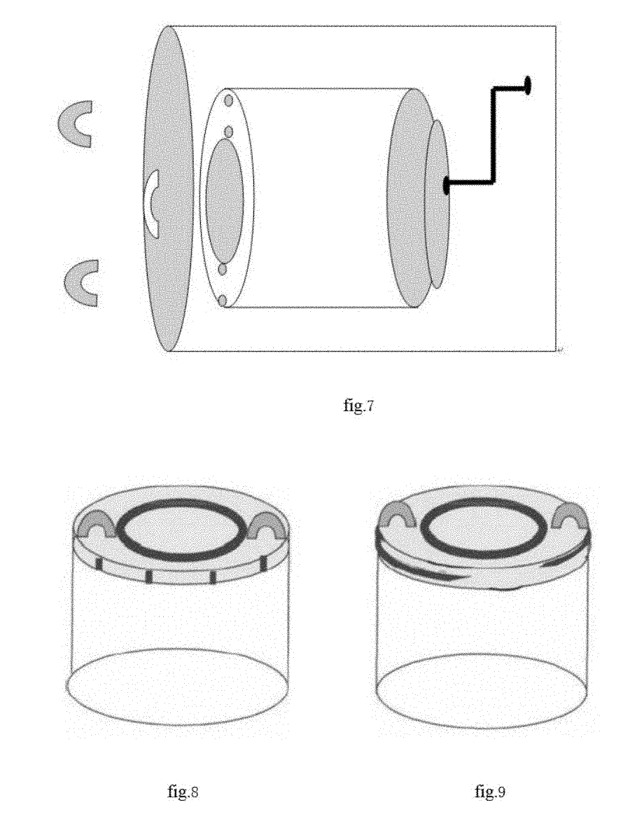

The out shell can be cube standing on the table, it has a front door (side door, out door), the inner tub can turning like the drum type washing machine vertically turning. After sticking the inner tub into the out shell it looks like so (like FIG. 1), the inner tub looks like so (like FIG. 2), after taking out the inner tub, the out shell looks like so (like FIG. 3). On the cover of the inner tub there are glass & turning handle. Inside of the out shell there is a turning bottom (from an other angle can also say the top of the out shell), on this turning bottom there is a metal turning stick. This turning stick replaced the belt in the washing machine to bring the inner tub turning as the transmitting took (like FIG. 4), the turning direction can be sometimes in plus direction sometimes in minus direction turning or always in one direction, the turning tempo can be also sometimes with different tempo or always with one tempo. The connecting methods between the inner tub & the out shell can be: screw thread type, chute type, gear type, pin type. After connected with the energy the pot begins to heat & at the same time the inner tub begins to turn. But if you feel maybe the front of the pot not closed very well you can also use this structure: the inner tub has the changeable handle (like FIG. 5), after taking out the handle you can stick the inner tub completely into the out shell, the out shell has also glass (like FIG. 6), this time is completely closed, after finished frying you can stick the handle onto the inner tub & draw it out (like FIG. 7), so you can keep of being scalded from the pot. The out door's closing methods can be also: turning handle type (like e-pressure cooker's big turning handle), screw thread type, chute type, gear type, pin type or heat-resisting rubber band.

(7) The Inner Tub without Turning Stick:

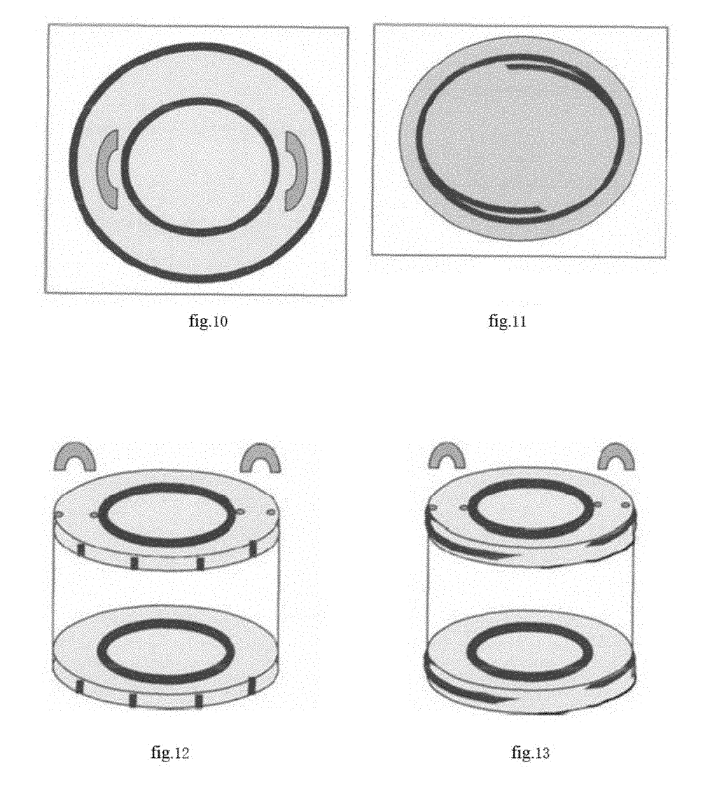

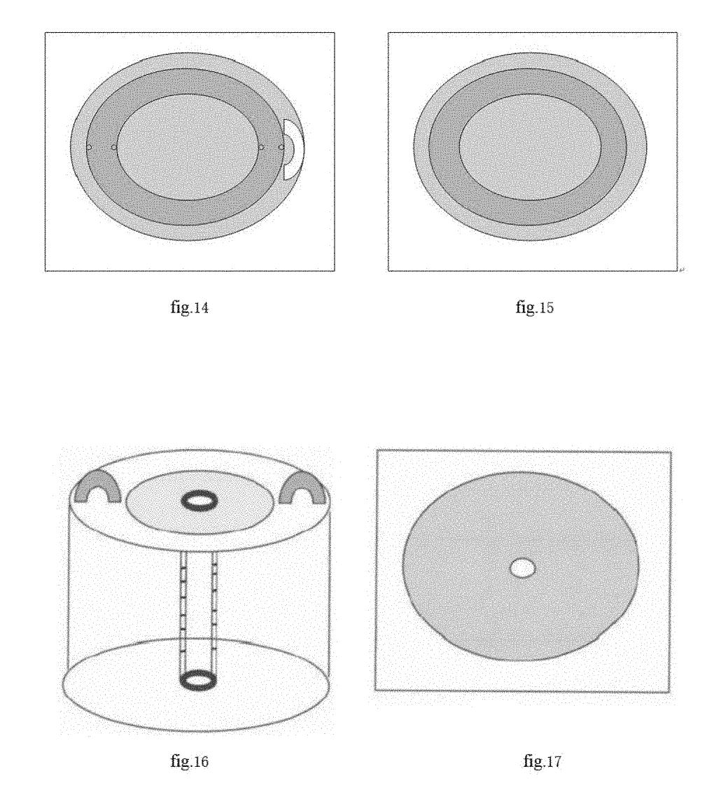

The bottom (from an other angle can also say the top) of the inner tub is connecting part (like FIG. 8, FIG. 9), after closing the out door the pot looks like so from the front (like FIG. 10), after taking out the inner tub the out shell looks like so from the front (like FIG. 11), the connecting methods can be also: screw thread type, chute type, gear type, pin type. This connecting part is also the transmitting tool, it can directly bring the inner tub turning, the connecting part can be one-ply or two-plies or more-plies, it can be on the top one ply on the bottom also one ply & from the back you can also see the turning food clearly (like FIG. 12, FIG. 13), the out shell has also glass on the back, after taking out the handle & sticking the inner tub into the closed out shell the pot looks like so from the front (like FIG. 14), from the back (like FIG. 15).

### (8) The Axis Brings the Inner Tub Turning:

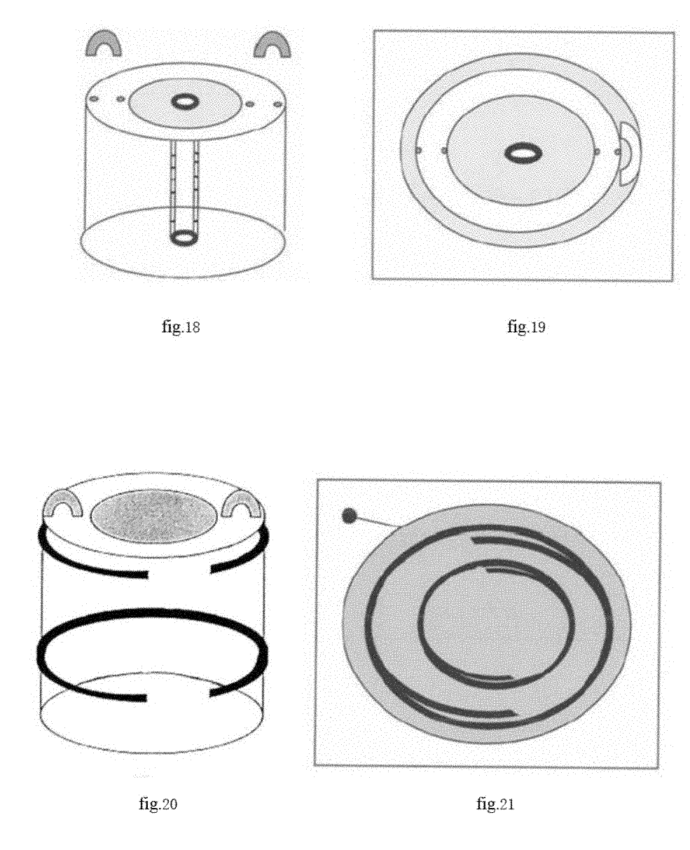

The inner tub has a axis (like FIG. 16), the out shell has also a axis (like FIG. 17), the axis is the connecting part also the transmitting tool to bring the inner tubturning. If you feel only axis connected with each other maybe not enough fixed can also add the connecting top & connecting bottom (like the front going pot). After taking out the handle & sticking the inner tub into the out shell it looks like so (like FIG. 18, FIG. 19).

(9) The Inner Tub Completely Connected with the Out Shell:

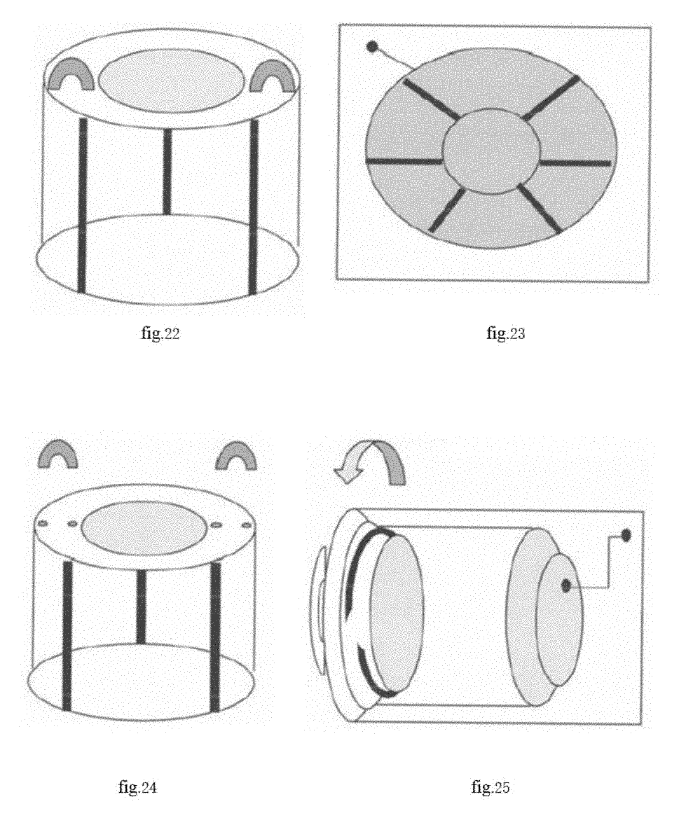

The out shell has two-plies, in the pot there is also an other out shell (from an other angle can also say the second inner tub), this ply can wrap the whole inner tub & can turning can also bring the inner tub turning. On this ply can be whole of (everywhere) screw thread, chute . . . to fix the inner tub (like FIG. 20, FIG. 21, FIG. 22, FIG. 23), the inner tub in the out shell looks like so (like FIG. 24)

### (10) Standable Pot:

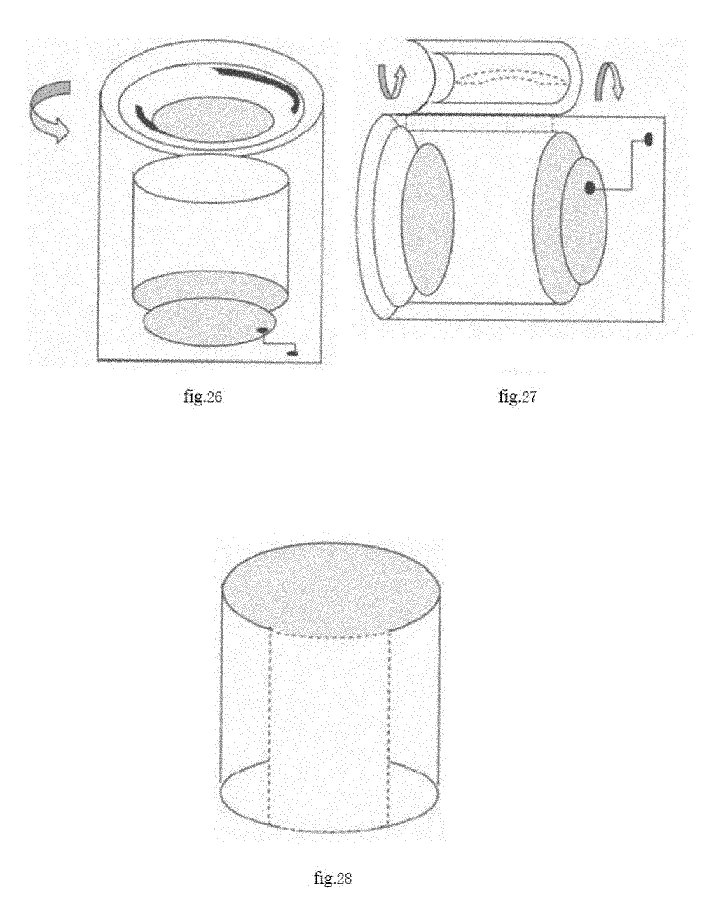

The pot can sometimes standing sometimes lying, when it's working, then is vertically turning, when you take out the food you can draw the pot standing & take the food out from the top door (out door). The door very closely connected the out shell with the inner tub, it can be such a machinery: a turning door, when you open the out door, you just turn it in minus direction & at the same time also brought the door of the inner tub with it, it is also parted from the inner tub, when you close the out door, you just turn it in plus direction & at the same time you also pressed it into the inner tub, the door of the inner tub is also closed (like FIG. 25, FIG. 26).

(6) The Inner Tub with Side Door:

The out shell doesn't need to be sometimes standing sometimes lying, it is opening from the top door. The inner tub doesn't need to be sometimes standing sometimes lying either, but is opening from the side (just side door), when you open the door, the inner tub just stopped turning and its door just right aimed at the out door, to easily take the food out (like FIG. 27). If you want to clean it, the inner tub can be also taken out & washed and then it can also standing on the table usually like so (like FIG. 28).

(9) The Inner Tub is like Pulsator Type Washing Machine:

The inner tub can transversely turning like the pulsator type washing machine & the door is also on the top. But except turning the inner tub can also sometimes up and down jumping. The turning stick inside can be very thick to bring the inner tub sometimes turning sometimes jumping.

### (10) Universally Turning Inner Tub:

The out shell doesn't move but the inner tub can sometimes vertically turning sometimes transversely turning, and when it is changing from vertical to transverse it can also turning, this time's turning is the universal turning (like a turning ball in every direction), or the form of the inner tub is just a ball to turn easily universally in every direction, except turning it can also sometimes up & down, right & left jumping.

### 2. Jumping Pot:

A closed stir-frying pot also has two parts: out shell and inner tub (the pot's size is similar as e-pressure cooker), the out shell is closed, the stuff of the inner tub is also not-stick stuff, the form of the inner tub can be any form can be like a tub can be also cube but it can't turning only up & down, right & left jumping, used the pumping power, gravity, striking power to stir-fry the food. If so except the (turning) stick on the bottom can also add a stick on the side & the turning stick has been named to rocking (or moving) stick.

### 3. Washing Pot:

A closed washing pot, its structure & the turning is similar as the washing machine (just with relative quick tempo) & the stir-frying pot described frontally in Detailed description of the invention: 1., but used the turning principle to wash the food, it has also out shell & inner tub, (the pot's size is similar as e-pressure cooker) the inner tub can also vertically like drum type washing machine turning can also transversely like pulsator type washing machine turning can also universally turning; used the gravity, the turning power (throwing power) and also the momentum by water-inpouring & water-outpouring; sometimes also added the up & down, right & left moving power to wash the food; the turning direction can be always in one direction or sometimes also in different directions, the turning tempo can be always with one tempo or sometimes with different tempo. The pot's detailed forms can also have some similar forms as the stir-frying pot described front, e.g.: The inner tub with turning stick, the top or bottom or axis connecting inner tubs & the inner tub with side door & universally turning inner tub . . . . But the inner tub can't maybe sometimes up & down, right & left jumping, because there is also momentum from the water, if so the power will be too big, therefore it can just sometimes by turning or between the turning up & down, right & left moving. The form of the inner tub can be also a tub or a ball etc. The stuff of the inner tub can be metal or plastic with a lot of holes or just completely gauze, or the non-stick stuff with some holes. The structure of the inner tub can be only one-ply or two-plies (inside & outside), or more-plies, the double plies can be so: the outside can be completely closed, the inside can be gauze & the outside turning in plus direction, the inside turning in minus direction & each with different tempo turning or the more plies (e.g. 3 plies) can be so: inside two plies are the gauze & outside is completely closed & each in different direction with different tempo turning. The pot can by water-inpouring also at the same time drain the water out & it can also by water-outpouring at the same time pour the water in (this time's momentum of the water is very big & the washing effect is very good), and by water-inpouring, water-outpouring the inner tub can also turning. You can pour the could water in it, you can also pour the hot, cooked water in, the inpouring-hole is on the top & the out door is also on the top, to easily add the forgotten foods. The washing program begins with water-inpouring, by inpouring also turning. The first inpouring can be so: after it poured in only the half (just by inpouring) begins to drain (almost 20 sec. after inpouring), used the momentum by water-inpouring & water-outpouring to wash the food, because it can also by water-outpouring pour the water in; the second inpouring can be so: once it finished inpouring just begins to drain (almost 40 sec. after inpouring); the third inpouring can be so: after it poured in also turning several turns, then drain (almost 60 sec. after inpouring); you can just add like so with your hands one time, two times . . . or by the full-automatical menus on the pot, e.g. one time washing with 3 times inpouring or one time washing with 4 times inpouring . . . . All together if you use this pot to wash the vegetables, almost within 2 minutes you will finish the washing, the more the momentum is the shorter the time is. This pot can also be used like so, by washing you can also cooking the water, e.g. after several times washing, at last the pot begins to heat, by heating also turning. There are also two other bottoms on the pot (for the heating): time bottom & temperature bottom & you can set them before you wash, and then it can heat at last to already set temperature and then can also turning to already set time. This pot can be also changed to the stir-frying pot described frontally just by some easy regulations, you need just easily to change this gauze inner tub to the non-stick inner tub back (like it in the stir-frying pot) then is ok, you can after washing stir-fry something.

### 4. Boiling Pot:

A boiling pot is for cleaning the food, you should add the water with the vegetables together into the pot, and when the water inside is cooked & the temperature reached 100° C., then disconnected (turned off) automatically. The form can be any form or similar as the front going pots. It also has out shell and inner tub (the pot's size is similar as e-pressure cooker). The stuff of the inner tub is non-stick stuff (the inner tub doesn't need a door). This pot is not completely closed, it has a top door (the door of the out shell), on the top door there are some small holes to dissipate the heat. This pot has a lot of useful functions: after boiled the meat will be disinfected; the shells of the vegetables (e.g. pumpkin . . . ) will be weak & very easy to shell; for some vegetables e.g. beans, turnips . . . after two times boiling can be directly eaten; some freezed food will be unfreezed, it can really replace some microwave's functions.

### 5. Cooking Pot:

A cooking pot is just the developed boiling pot, it is just so, after the water cooked & the temperature reached 100° C. can't disconnected (turned off) automatically but continuously cooking with small fire. On the top door there are also some small holes or sometimes you can also open the top door, because the fire is small. There are two choices on the pot: boiling, cooking. If you want to cook, the cooking choice has also two bottoms: the time bottom & the fire-power bottom. You can set, with 20% fire-power cooking for 10 min., or 30% fire-power cooking for 20 min . . . before you cook & then after the water cooked it will continuously cooking with your already set time & fire-power, you can also regulate them any time during the cooking, normally the cooking time can't be too long just about 30 min., because if longer you can use the e-pressure cooker. The biggest benefit of this pot is the cooking tempo will be much quicker then you cooking on the normal oven, because it's almost completely closed & the heat comes from all sides not only from the bottom.

### 6. Steaming Pot:

A steaming pot is just the developed cooking pot, the difference is just on its inner tub there are some fillisters and they have also the suitable grates, if you stick the gates into the fillisters you can steam the food on the grates.

### 7. Stir-Frying, Washing, Boiling, Cooking, Steaming United Universal Pot:

All the 5 pots: stir-frying, washing, boiling, cooking, steaming pot described frontally, they all have some same parts, therefore they can be with some small regulations easily changed to each other (so is 5 in 1 pots), or parted from each other and used as 5 extra independent pots, or freely combined with each other, e.g. stir-frying, washing, boiling 3 in 1 pots or washing, boiling 2 in 1 pots etc. You can make like so: After washing you can stir-fry something, if after then you want to boil something you can just easily change the door of the inner tube (you can just take the door off) or the door of the out shell (you can maybe only change a part of the out door, e.g. change the glass to the cover with a lot of holes) . . . . So you can change them all to each other, either change the whole inner tub, or the door or just a part of them. If the inner tub has two-plies, after washing the out shell will be also completely dry & you can after washing stir-fry something very safely. All these pots have a same benefit, they all can be disconnected (turned off) automatically & plus the already existed electronic equipments e.g. microwave, chopping machine, beating machine . . . so is really almost realized that, without handwork only mechanically full-automatically cooking, therefore it can be called universal pot. The cost of this pot is also very cheap, & it can be drived by electricity or other energy e.g. electromagnetic energy . . . .

1. A stir-frying pot used the turning principle to stir-fry the food, the structure & the turning is similar as the washing machine, it has two parts: the out shell and the inner tub, the inner tub can lying vertically turning can also standing transversely turning can also universally turning, the vertically turning direction is same as drum type washing machine's turning direction, the transversely turning direction is same as pulsator type washing machine's turning direction. After connected with the energy the pot begins to heat, at the same time the inner tub begins to turn, by turning used the vertically turning gravity & turning power (throwing power), and also used the transversely turning turning power and added the heat from the pot; sometimes also added the up & down, right & left jumping power, striking power to stir-fry the food; the turning direction can be always in one direction or sometimes also in different direction, the turning tempo can be always with one tempo or sometimes with different tempo.

2. According to the stir-frying pot described in claim of the rights No. 1, the stuff of its inner tub is non-stick stuff, the structure of the connecting part between the out shell & the inner tub can be: screw thread type, chute type, gear type, pin type or heat-resisting rubber band . . . the connecting part can be anywhere & any form in the pot.

3. According to the stir-frying pot described in claim of the rights No. 1, it can be the following forms: (1) The bottom or the top of the out shell can turning & can bring the inner tub turning, between the out shell and the inner tub there is a metal turning stick (replaced the belt in the washing machine) to bring the inner tub turning as the transmitting tool. (2) The bottom or the top or the axis . . . of the out shell can be connected with the inner tub & can as the transmitting tool directly bring the inner tub turning. (3) The out shell and the inner tub completely connected with each other, the out shell wrapped the whole inner tub to turn, just like two-ply inner tub. (4) The pot can sometimes standing sometimes lying, when it's working, then is vertically turning, when you take out the food you can draw the pot standing & take the food out from the top door (out door). (5) The out shell doesn't need to be sometimes standing sometimes lying, it is opening from the top door, the inner tub doesn't need to be sometimes standing sometimes lying either, but is opening from the side (just side door), when you open the door, the inner tub is stopped turning and its door just right aimed at the out door, to easily take the food out. (6) The inner tub can transversely turning like the pulsator type washing machine & the inner tub can also sometimes up and down jumping. (7) The out shell doesn't move but the inner tub can sometimes vertically turning sometimes transversely turning, and when it is changing from vertical to transverse it can also turning, this time's turning is the universal turning (like a turning ball in every direction), or the form of the inner tub is just a ball to turn easily universally in every direction, except turning it can also sometimes up & down, right & left jumping. (8) Some pots used a new changeable pot's handle to keep of being hurt from the heat, when you cooking can take it out when you take the food can stick it on the pot.

4. A stir-frying pot also has two parts: out shell and inner tub, the out shell is closed, the stuff of the inner tub is also not-stick stuff, the form of the inner tub can be any form can be also cube but it can't turning only up & down, right & left jumping, used the jumping power, gravity, striking power to stir-fry the food.

5. A washing pot, its structure & the turning is similar as the washing machine & the stir-frying pot described in claim of the rights No. 1, but used the turning principle to wash the food, it has also out shell & inner tub, the inner tub can also vertically turning like drum type washing machine can also transversely turning like pulsator type washing machine can also universally turning & can also turning by water-inpouring, water-outpouring; used the gravity, the turning power (throwing power) and also the momentum by water-inpouring & water-outpouring; sometimes also added the up & down, right & left moving power to wash the food; the turning direction can be always in one direction or sometimes also in different direction, the turning tempo can be always with one tempo or sometimes with different tempo.

6. According to the washing pot described in claim of the rights No. 5, it has the following traits: (1) The transmitting tool to bring the inner tub turning is better a metal turning stick, because this pot has also an other function to be used with other pots together. (2) The top or bottom or axis . . . any where of the out shell can be connected with the inner tub & can as the transmitting tool directly bring the inner tub turning. (3) The out shell doesn't need to be sometimes standing sometimes lying, it is opening from the top door the inner tub doesn't need to be sometimes standing sometimes lying either, but is opening from the side (just side door), when you open the door, the inner tub is stopped turning and its door just right aimed at the out door. (4) The out shell doesn't move but the inner tub can sometimes vertically turning sometimes transversely turning, and when it is changing from vertical to transverse it can also turning, this time's turning is the universal turning, or the form of the inner tub is just a ball to turn easily universally in every direction, except turning the inner tub can also sometimes up & down, right & left moving. (5) The stuff of the inner tub can be metal, plastic . . . stuff with a lot of holes or just completely a gauze, or the non-stick stuff with some holes. (6) The structure of the inner tub can be only one ply or two-ply (inside & outside), or more-ply, the double plies can be so: the outside can be completely closed, the inside can be a gauze & each in different direction each with different tempo turning, or the more plies (e.g. 3 plies) can be so: inside two plies are the gauze & outside is completely closed & each in different direction each with different tempo turning. (7) The pot can by water-inpouring also at the same time drain the water out & it can also by water-outpouring at the same time pour the water in, and by water-inpouring, water-outpouring the inner tub can also turning. (8) You can pour the could water in it, you can also pour the hot, cooked water in, the inpouring-hole is on the top & the out door is also on the top, to easily add the forgot foods.

7. According to the washing pot described in claim of the rights No. 5 & No. 6, by washing you can also cooking the water, e.g. after several times washing, at last the pot begins to heat, by heating also turning & it can heat to the specifical temperature (already set temperature) and then can also turning to the specifical time (already set time).

8. A boiling pot, used the principle, when the water inside cooked and the temperature reached 100° C., then disconnected (turned off) automatically, it has also out shell & inner tub, the out shell can be metal or other stuff, the stuff of the inner tub is non-stick stuff, on the top door there are some small holes to dissipate the heat.

9. A cooking pot & a steaming pot, their structure are similar as the boiling pot described in claim of the rights No. 8, but they can't automatically turn off, when the temperature reached 100° C., they will automatically with the specifical fire-power (already set fire-power) continuously cooking to the specifical time (already set time).

10. According to the cooking pot & steaming pot described in claim of the rights No. 9, the stuff of their inner tubs are non-stick stuff, and on the steaming pot's inner tub, there are some fillisters and they have also the suitable grates, if you stick the grates into the fillisters you can steam the food.

11. According to the stir-frying pot, washing pot, boiling pot, cooking pot & steaming pot described in claim of the rights No. 1. 4. 5. 8. 9, all the 5 pots they all have some same parts, they can be with some small regulations easily changed to each other (so is 5 in 1 pots), or parted from each other and used as 5 extra independent pots, or freely combined with each other, e.g. stir-frying, washing, boiling 3 in 1 pots or washing, boiling 2 in 1 pots etc.

12. This invention has described only the practical & better concrete forms, but its protection is not only in this limit, it should include also this invention's easy changes & substitutions, which every technician can easily think of in the similar technical field.
